(19) United States
(12) Patent Application Publication
(10) Pub. No.: US 2021/0090135 A1
(43) Pub. Date: Mar. 25, 2021

(54) COMMODITY INFORMATION NOTIFYING SYSTEM, COMMODITY INFORMATION NOTIFYING METHOD, AND PROGRAM

(71) Applicant: TOSHIBA TEC KABUSHIKI KAISHA, Tokyo (JP)

(72) Inventor: Nobuhiro INAGAWA, Numazu Shizuoka (JP)

(73) Assignee: TOSHIBA TEC KABUSHIKI KAISHA, Tokyo (JP)

(21) Appl. No.: 16/916,812

(22) Filed: Jun. 30, 2020

(30) Foreign Application Priority Data
Sep. 19, 2019 (JP) 2019-170004

(51) Int. Cl. G06Q 30/02; G06Q 30/06; G06Q 10/08; G06F 16/9535; G06F 16/951; G06K 9/00

(52) U.S. Cl. CPC G06Q 30/0281; G06Q 30/0613; G06Q 10/087; G06Q 30/0639; G06K 9/00302; G06Q 30/0631; G06F 16/9535; G06F 16/951; G06Q 30/0623

(57) ABSTRACT

A commodity information notifying system includes a commodity stock database for managing stock information of commodities in a store, a customer information database for managing customer information, a customer-store-visit detecting unit configured to detect a store visit of a customer registered in the customer information database, a customer-action recognizing unit configured to recognize an action of the customer using a surveillance camera disposed in the store, and a commodity-information notifying unit configured to, if a commodity search action of the customer is recognized by the customer-action recognizing unit, acquire commodity information of a search target commodity from the commodity stock database, and transmit the commodity information to a portable information terminal carried by the customer.

### CROSS-REFERENCE TO RELATED APPLICATION

This application is based upon and claims the benefit of priority from Japanese Patent Application No. 2019-170004, filed in Sep. 19, 2019, the entire contents of which are incorporated herein by reference.

### FIELD

Embodiments described herein relate generally to a commodity information notification system, a commodity information notification method, and a program.

### BACKGROUND

In related art, there is a system that grasps commodity stocks in a store and enables, in association with an EC site or the like, customers (users) to confirm commodity stock information (stock quantities) (see JP-A-2017-220006 (Patent Literature 1)). Customers can confirm a commodity stock state before visiting the store by using such a system.

However, display positions of commodities in the store often change according to a commodity stock state and a sales state. Accordingly, the customers sometimes search for commodities in the store, and it is likely that the customers give up on purchasing the commodity.

Therefore, simple introduction of such a system cannot meet the needs of the customers.

### DESCRIPTION OF THE DRAWINGS

FIG. 1 is a schematic diagram illustrating a commodity information notification system in an embodiment;

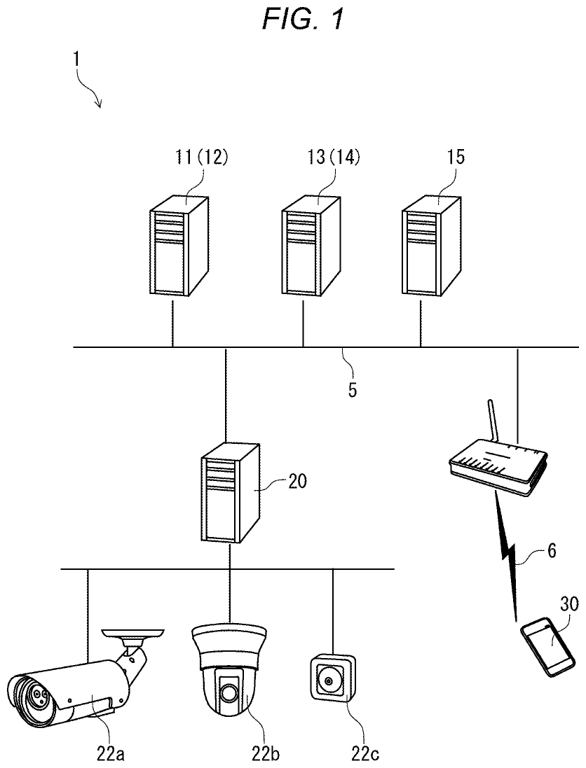

FIG. 2 is a diagram illustrating a hardware configuration of the commodity information notification system according to an embodiment;

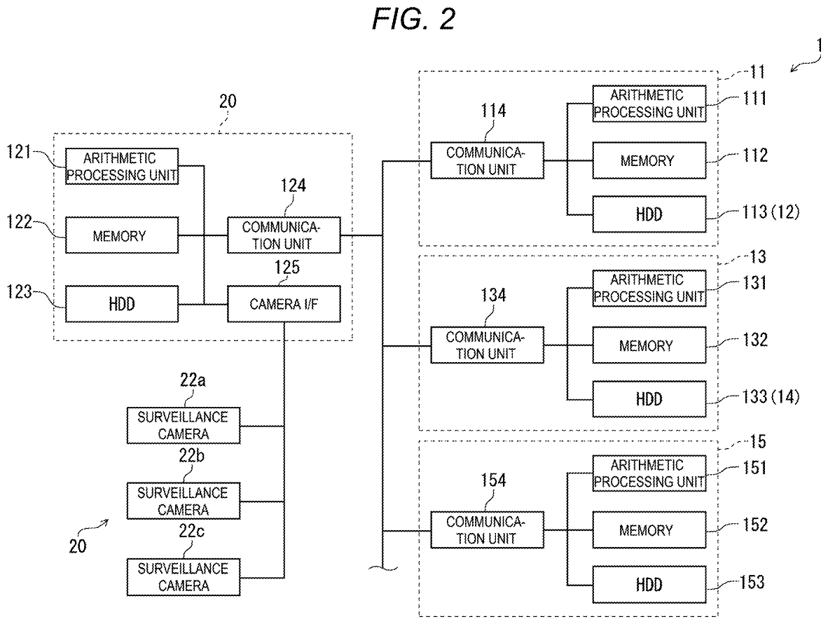

FIGS. 3A to 3D are diagrams illustrating a data table: FIG. 3A illustrates customer information, FIG. 3B illustrates commodity information, FIG. 3C illustrates purchase planned commodity information, and FIG. 3D illustrates commodity purchase history information;

FIG. 4 is a sequence chart illustrating a commodity information notification method according to an embodiment;

FIG. 5 is a diagram illustrating a display example of a notification for inquiring about a search target commodity according to an embodiment;

FIG. 6 is a diagram illustrating a display example of display position information of the search target commodity according to an embodiment;

FIG. 7 is a sequence chart illustrating a modification 1 of the commodity information notification method according to an embodiment;

FIG. 8 is a sequence chart illustrating a modification 2 of the commodity information notification method according to an embodiment; and

FIG. 9 is a diagram illustrating a display example of commodity information of the search target commodity and a substitute according to an embodiment.

### DETAILED DESCRIPTION

Embodiments described herein can be configured to provide a commodity information notification system and a commodity information notification method that, if a customer visiting a store searches for commodities, can notify the customer of commodity information and the like.

A commodity information notification system according to an embodiment includes: a commodity stock database for managing stock information of commodities in a store; a customer information database for managing customer information; a customer-store-visit detecting unit configured to detect a store visit of a customer registered in the customer information database; a customer-action recognizing unit configured to recognize an action of the customer using a surveillance camera disposed in the store; and a commodity-information notification unit configured to, if a commodity search action of the customer is recognized by the customer-action recognizing unit, acquire commodity information of a search target commodity from the commodity stock database, and transmit the commodity information to a portable information terminal carried by the customer.

In the commodity information notification system according to the embodiment, the customer-action recognizing unit may analyze a visual line direction of the customer, and the commodity-information notification unit may estimate the search target commodity based on display position information of commodities stored in the commodity stock database and visual line information of the customer.

In the commodity information notification system according to the embodiment, the commodity-information notification unit may estimate the search target commodity based on a commodity purchase history stored in the customer information database and position information of the customer.

In the commodity information notification system according to the embodiment, the commodity-information notification unit may estimate the search target commodity based on purchase planned commodity information registered in the commodity stock database and position information of the customer.

A commodity information notification method according to an embodiment includes: detecting, with a customer-store-visit detecting unit, a store visit of a customer registered in a customer information database; recognizing an action of the customer using a surveillance camera disposed in a store; and, if a commodity search action of the customer is recognized, acquiring commodity information of a search target commodity from a commodity stock database and transmitting the commodity information to a portable information terminal carried by the customer.

A program according to an embodiment causes a computer to function as commodity-information transmitting means for, if acquiring store visit information of a customer registered in a customer information database and commodity action information using a surveillance camera disposed in a store, acquiring commodity information of a search target commodity from a commodity stock database and transmitting the commodity information to a portable information terminal carried by the customer.

A commodity information notification system and a commodity information notification method according to some embodiments are explained below with reference to the drawings. In the drawings, the same components are denoted by the same reference numerals and signs.

<Commodity Information Notification System>

Referring more specifically to FIG. 13D, the commodity information notification system 1 includes a commodity stock management server 11, a customer information management server 13, a commodity information notification server 15, and a customer-action recognizing unit 20.

The commodity stock management server 11 and the like are connected to one another via a LAN 5.

The commodity stock management server 11 is a computer that manages commodity information of sales commodities in, for example, an electronics retail store or a supermarket. The commodity stock management server 11 includes an arithmetic processing unit 111, a memory 112, a hard disk 113, and a communication unit 114.

The commodity stock management server 11 includes a commodity stock database 12 in the hard disk 113. Commodity information J6 is stored in the commodity stock database 12.

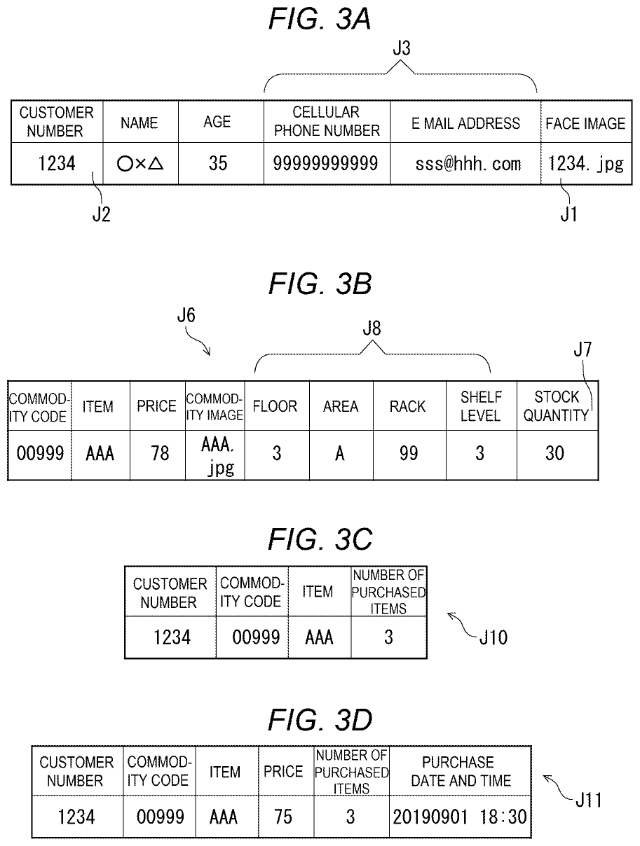

The commodity information J6 includes a commodity code, an item, a price, a commodity image, display position information J8, and stock information J7 (see FIG. 3B).

The display position information J8 is position information of a commodity in a store and can include a floor number, an area, a rack number, and a shelf level number and is, specifically, position information such as “a third floor, an area A, a rack No. 99, a third level”.

The stock information J7 is a stock quantity of a commodity displayed in the store and is stored on a real time basis, in a time unit, or in a day unit.

In a commodity stock database 12 (the hard disk 113), a history of the commodity information J6 of commodities (in particular, a history of the display position information J8) is also saved.

The customer information management server 13 is a computer that manages customer information. The customer information management server 13 includes an arithmetic processing unit 131, a memory 132, a hard disk 133, and a communication unit 134.

The customer information management server 13 includes a customer information database 14 in the hard disk 133. Customer information and commodity purchase history information J11 are stored in the customer information database 14.

The customer information includes a customer number, a name, an age, customer terminal information J3 (a cellular phone number and an E-mail address), and face image data J1 (see FIG. 3A).

The commodity purchase history information J11 is information concerning commodities purchased in the past and includes a customer number, a commodity code, an item, a price, the number of purchased items, and a purchase date and time (see FIG. 3D).

The commodity information notification server (a commodity-information notification unit or a computer) 15 is a computer that provides a stock status of sales commodities and the display position information J8 to customers. The commodity information notification server 15 includes an arithmetic processing unit 151 (e.g. processor), a memory 152, a hard disk 153, and a communication unit 154.

Various computer programs are saved in the hard disk 153 of the commodity information notification server 15. For example, a program for causing the commodity information notification server 15 to function as commodity information transmitting means for, if acquiring store visit information (a customer number J2) of a customer registered in the customer information database 14 and customer action information J4 and J5 obtained using a surveillance camera 22 disposed in the store, acquiring commodity information J6 (J7 and J8) of a search target commodity from the commodity stock database 12 and transmitting the commodity information J6 to a portable information terminal 30 carried by the customer.

The commodity information notification server 15 acquires stock information J7 of sales commodities from the commodity stock database 12 of the commodity stock management server 11. The commodity information notification server 15 also acquires the display position information J8 of sales commodities from the commodity stock database 12.

The commodity information notification server 15 acquires, for example, a cellular phone number of a portable information terminal carried by the customer from the customer information database 14 of the customer information management server 13. The commodity information notification server 15 provides various kinds of information concerning sales commodities to the customer who is doing shopping. That is, if the customer is searching for a commodity, the commodity information notification server 15 transmits the stock information J7 and the display position information J8 of the commodity to the portable information terminal of the customer.

As explained below, the commodity information notification server 15 acquires information (e.g., customer action information, commodity search action) indicating that “a customer is searching for a commodity” from the customer-action recognizing unit 20. Then, the commodity information notification server 15 estimates the commodity that the customer is searching for (a search target commodity) and provides information (the display position information J8 and the like) concerning the search target commodity to the customer.

If estimating the commodity target commodity, the commodity information notification server 15 can also acquire information concerning “a visual line direction of the customer” (customer visual line information J5) from the customer-action recognizing unit 20. The customer-action recognizing unit 20 selects, based on setting position information of a surveillance camera 22c, the customer visual line information J5, and the display position information of sales commodities, a commodity to which the customer pays attention (e.g., a commodity at which the customer gazes). That is, the commodity information notification server 15 specifies the commodity that the customer is searching for (the search target commodity).

The commodity information notification server 15 can also recognize (e.g., estimate) that a preregistered purchase planned commodity as the commodity that the customer is searching for.

The commodity information notification server 15 is a computer that provides and manages a Web site (for example, an electronic commerce site). The commodity information notification server 15 is connected to the Internet and places the stock information J7 of sales commodities on the Web site. The customer operates a smartphone 30, a personal computer, or the like to access the Web site of the commodity information notification server 15. Consequently, the customer can acquire information such as presence or absence of commodities that the customer desires to purchase and the stock information J7 in this Web site before visiting the store.

The commodity information notification server 15 acquires information concerning a purchase planned commodity (purchase planned commodity information J10) from the customer via the Internet. In other words, the customer can register the purchase planned commodity in the Web site provided by the commodity information notification server 15.

Specifically, the customer accesses the Web site from the information terminal such as the smartphone 30 and inputs a member number (e.g., a customer number) to open a member only page (e.g., a my page). The my page is a customer exclusive page in which various kinds of information customized for each customer such as a my menu, a my news, a charge, and point information can be displayed and browsed.

The customer can create a shopping list in the member only page. The customer selects a commodity and the number of purchased items displayed in the Web site, whereby a shopping list is created. Information (e.g., an item, the number of purchased items, and the like) listed in the shopping list is transmitted from the commodity information notification server to the customer information management server 13 and registered in the customer information database 14 as the purchase planned commodity information J10.

The purchase planned commodity information J10 includes a customer number, a commodity code, an item, and the number of purchased items (see FIG. 3C).

If the customer creates the shopping list in this way, the commodity information notification server 15 can recognize, as the commodity that the customer is searching for (the search target commodity), the purchase planned commodity registered in the my page of the Web site.

The customer-action recognizing unit (a customer-store-visit detecting unit) 20 is a computer that performs customer store visit detection and customer action recognition. The customer-action recognizing unit 20 includes an arithmetic processing unit 121 (e.g., processor), a memory 122, a hard disk 123, a communication unit 124, and a camera I/F 125.

A plurality of surveillance cameras 22 (e.g., network cameras) are connected to the camera I/F 125 of the customer-action recognizing unit 20. The customer-action recognizing unit 20 analyzes images photographed by the surveillance cameras 22 and detects and recognizes customer store visits, customer actions, and the like.

The arithmetic processing unit 121 of the customer-action recognizing unit 20 detects a store visit of a customer using a surveillance camera 22a set near an entrance of the store. The customer-action recognizing unit 20 acquires face image data of the store visitor (the customer) photographed by the surveillance camera 22a. The customer-action recognizing unit 20 determines (detects), based on the face image data, that the customer registered in the customer information database 14 is visiting the store.

The customer-action recognizing unit 20 recognizes, using surveillance cameras 22b and 22c set in the store, an action or the like of the customer whose store visit is detected.

The surveillance camera 22b is disposed on a ceiling, a sidewall, a column, or the like of the store and photographs a moving image of actions of a customer. The surveillance camera 22c is disposed on a display shelf or the like and photographs a face image of a customer who pays attention to a displayed commodity. The surveillance camera 22c photographs, in particular, both the eyes of the customer.

The customer-action recognizing unit 20 acquires moving image data of the customer photographed by the surveillance camera 22b and performs an action analysis for the customer. In particular, the customer-action recognizing unit 20 recognizes whether an action of the customer is a “commodity searching” action.

The customer-action recognizing unit 20 acquires moving image data of the customer photographed by the surveillance camera 22c and analyzes a visual line direction of the customer. Consequently, the customer-action recognizing unit 20 recognizes a direction that the customer is looking.

<Commodity Information Notification Method>

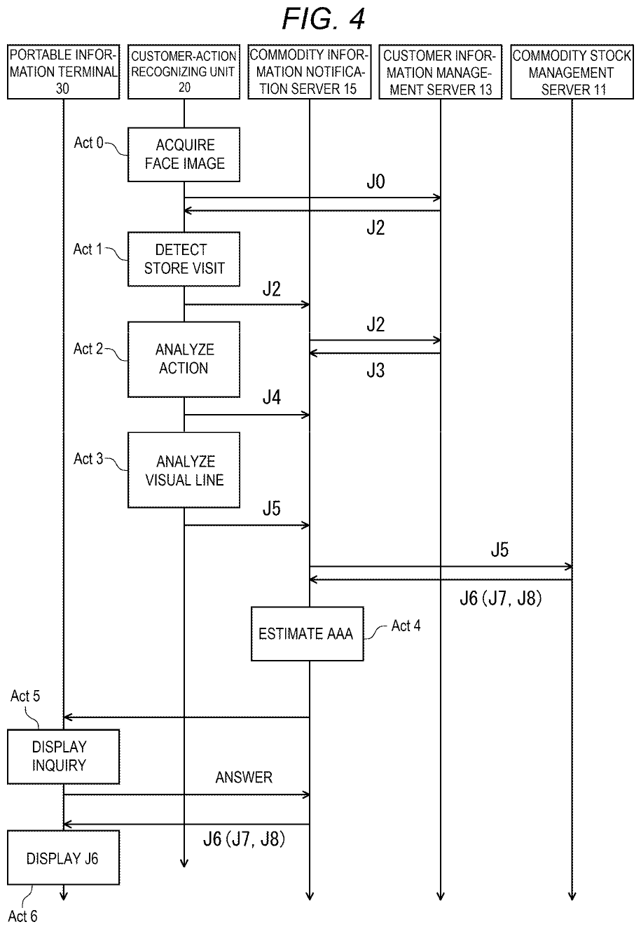

Referring now to FIGS. 4-6, in the commodity information notification method in the embodiment, the customer-action recognizing unit 20 first detects a store visit of the customer registered in the commodity information database 14.

As explained above, the customer-action recognizing unit 20 acquires face image data of a store visitor photographed by the surveillance camera 22a set near the entrance of the store (Act 0).

The customer-action recognizing unit 20 transmits face image data J0 to the customer information management server 13 and instructs the customer information management server 13 to search through the customer information database 14.

The customer information management server 13 retrieves the face image data J1 included in a large number of customer information. The customer-action recognizing unit 20 collates the face image data J0 of the store visitor and the face image data J1 of the customer information. If the face image data J0 of the store visitor coincides with the face image data J1 of any member, the customer information management server 13 returns the customer number J2 to the customer-action recognizing unit 20.

As a method for face recognition, an existing method can be used.

If receiving the customer number J12 from the customer information database 14, the customer-action recognizing unit 20 determines (detects) that the customer visits the store (Act 1).

The customer-action recognizing unit 20 continues the following processing only for a customer coinciding with the face image data J0 and J1 (the customer registered in the customer information database 14).

Subsequently, the customer-action recognizing unit 20 transmits the customer number J2 to the commodity information notification server 15 as store visit information.

If receiving the customer number J2, the commodity information notification server 15 transmits the customer number J2 to the customer information management server 13 and instructs the customer information management server 13 to search through the customer information database 14.

The customer information management server 13 retrieves customer information based on the customer number J2 to specify the customer (a member) and returns the customer terminal information J3 (the E-mail address and the cellular phone number) of the customer to the commodity information notification server 15.

Subsequently, the customer-action recognizing unit 20 performs action recognition (Act 2) and a visual line analysis (Act 3) for the customer visiting the store.

As explained above, the customer-action recognizing unit 20 acquires moving image data of the store visitor photographed by the surveillance cameras 22b and 22c set in the store. The surveillance camera 22b mainly photographs the entire body of the customer to capture an action of the customer. The surveillance camera 22c mainly photographs the face of the customer, in particular, both the eyes of the customer.

Prior to the action recognition and the like, the customer-action recognizing unit 20 performs face recognition of the customer using the moving image data photographed by the surveillance cameras 22b and 22c. The customer-action recognizing unit 20 specifies, with the face recognition, the customer being photographed out of customers whose store visits are already detected.

If the customer is specified by the face recognition, the customer-action recognizing unit 20 performs an action analysis and a visual line analysis for the customer based on the moving image data. The action analysis and the visual line analysis are simultaneously performed in parallel.

In the action analysis, the customer-action recognizing unit 20 analyzes the moving image data of the surveillance camera 22b. Specifically, the customer-action recognizing unit 20 determines (recognizes) whether an action of the customer is a “commodity searching” action.

For example, if the customer is wandering around a specific display shelf or if the customer stays (e.g., stands or squats down) in front of a display shelf for a fixed time or longer, the customer-action recognizing unit 20 recognizes that the customer is “searching for a commodity”.

As a method for the behavior analysis (e.g., behavior recognition), an existing method can be used.

The customer-action recognizing unit 20 transmits a result of the recognition (e.g., the customer action information J4) to the commodity information notification server 15.

In the visual line analysis, the customer-action recognizing unit 20 analyzes the moving image data of the surveillance camera 22c. This analysis is performed if the customer stays in front of a specific display shelf for the fixed time or longer. Specifically, the customer-action recognizing unit 20 recognizes a visual line direction of the customer, that is, determines a direction that the customer is looking.

As a method for the visual line analysis (e.g., visual recognition), an existing method can be used.

The customer-action recognizing unit 20 transmits a result of the recognition (the customer visual line information J5) to the commodity information notification server 15.

If receiving the customer action information J4 and the customer visual line information J5 from the customer-action recognizing unit 20, the commodity information notification server 15 transmits the customer visual line information J5 to the commodity stock management server 11 and instructs the commodity stock management server 11 to search through the commodity stock database 12.

The commodity stock management server 11 retrieves the commodity information J6 (e.g., the display position information J8, including a history) based on the customer visual line information J5 and specifies commodities displayed ahead of the visual line of the customer, that is, a plurality of commodities displayed. The commodity stock management server 11 returns the commodity information J6 (including a history) of these commodities to the commodity information notification server 15.

The commodity information notification server 15 refers to the commodity information (the stock information J7) and the commodity history information (the display position information J8) received from the commodity stock management server 11 and selects a commodity out of stock or a commodity, a display position of which changes from the last store visit time.

The commodity information notification server 15 estimates the commodity as the commodity that the customer searches for (e.g., the search target commodity) (Act 4). Specifically, the commodity information notification server 15 estimates that the search target commodity is AAA (for example, fermented soybeans).

Subsequently, the commodity information notification server 15 transmits an inquiry concerning the search target commodity to the portable information terminal (e.g., the smartphone 30 or the like) carried by the customer.

Since the commodity information notification server 15 acquires the customer terminal information J3 (the cellular phone number and the E main address) in advance, the commodity information notification server 15 can transmit the commodity information J6 to the portable information terminal.

The commodity information notification server 15 may transmit the commodity information J6 via a cellular phone line (an electric communication line). If the portable information terminal carried by the customer is connected to a wireless LAN 6 (an electric communication line) provided in the store, the commodity information notification server 15 may transmit the commodity information J6 via the wireless LAN 6.

The smartphone 30 displays a notification received from the commodity information notification server 15 on a display D (Act 5).

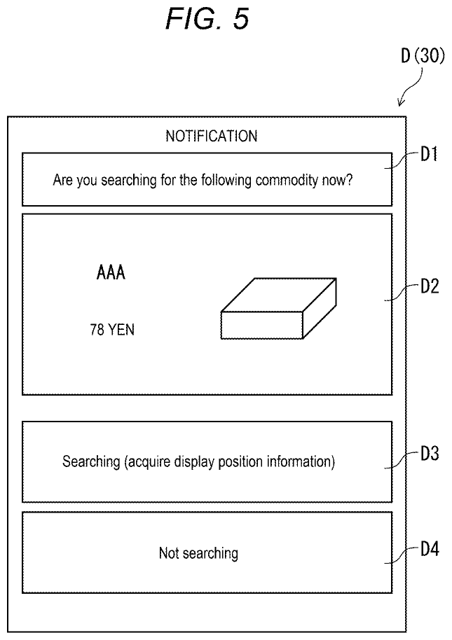

For example, as illustrated in FIG. 5, a message “Are you searching for the following commodity now?” is displayed in a region D1 of the display D.

The commodity information J6 of the search target commodity (AAA) is displayed in a region D2. Specifically, “AAA, 78 yen” is displayed. A thumbnail image of AAA is also displayed.

An inquiry message “searching (acquire display position information)” is displayed in a region D3. An inquiry message “not searching” is displayed in a region D4.

In response to this inquiry, the customer touches the region D3 or the region D4 of the display D and answers. The customer can select and answer “searching (acquire display position information)” or “not searching”.

If the customer selects and answers “searching (acquire display position information)” (touches the region D3), the commodity information notification server 15 transmits the display position information J8, the stock information J7, and the like of the search target commodity AAA to the smartphone 30.

The smartphone 30 displays the commodity information J6 (the stock information J7 and the display position information J8) received from the commodity information notification server 15 on the display D (Act 6).

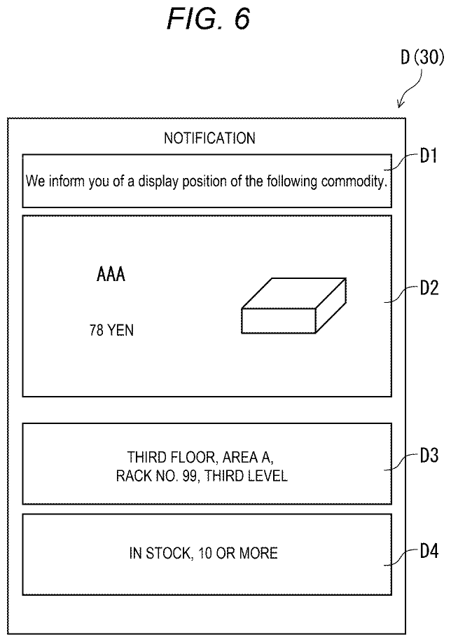

For example, as illustrated in FIG. 6, a message “We inform you of the display position of the following commodity” is displayed in the region D1 of the display D.

The commodity information J6 of the search target commodity (AAA) is displayed in the region D2. Specifically, “AAA, 78 yen” is displayed. The thumbnail image of AAA is also displayed.

The display position information J8 is displayed in the region D3. Specifically, “third floor, area A, rack No. 99, third level” is displayed.

Stock information J7 is displayed in the region D4. Specifically, “in stock, 10 or more” is displayed.

Consequently, the customer can surely find a commodity that the customer desires to purchase. Accordingly, the customer can avoid consuming a useless time for searching for commodities in the store. Dissatisfaction and distrust of the customer against the store can be eased.

If the customer selects and answers “not searching” (touches the region D4) in Act 5, processing returns to Act 2 and Act 3.

<Commodity Information Notification Method: Modification 1>

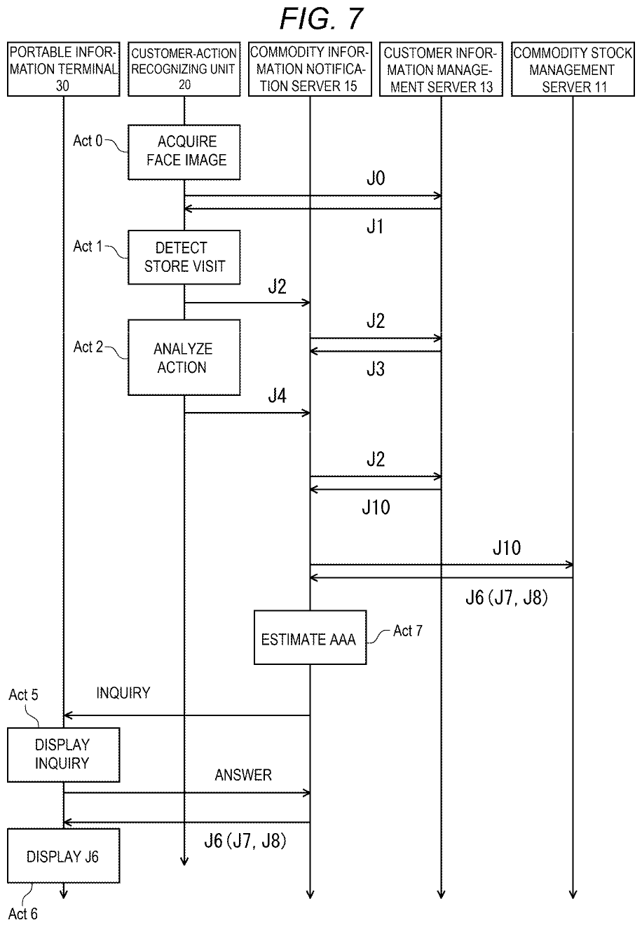

Referring now to FIG. 7, the visual line analysis in Act 3 is sometimes not completed. That is, the customer visual line information J5 is sometimes not obtained from the customer-action recognizing unit 20. This occurs, for example, if the customer is wandering around. In such a case, the commodity information notification server 15 acquires information replacing the customer visual line information J5.

That is, if receiving only the customer action information J4 from the customer-action recognizing unit 20, the commodity information notification server 15 transmits the customer number J2 to the customer information management server 13 and instructs the customer information management server 13 to search through the customer information database 14.

The customer information management server 13 retrieves customer information based on the customer number J2 and returns the purchase planned commodity information J10 to the commodity information notification server 15.

If receiving the purchase planned commodity information J10, the commodity information notification server 15 transmits the purchase planned commodity information J10 (e.g., a commodity code and the like) to the commodity stock management server 11 and instructs the commodity stock management server 11 to search through the commodity stock database 12.

The commodity stock management server 11 specifies a commodity based on the purchase planned commodity information J10. The commodity stock management server 11 returns the commodity information J6 including a history of the commodity to the commodity information notification server 15.

If receiving a plurality of kinds of commodity information J6 from the commodity stock management server 11, the commodity information notification server 15 refers to a commodity information history (the display position information J8) and selects a commodity out of stock or a commodity, a display position of which changes from the last store visit time.

The commodity information notification server 15 estimates the commodity as a commodity that the customer is searching for (e.g., a search target commodity) (Act 7). Specifically, the commodity information notification server 15 estimates that the search target commodity is AAA (for example, fermented soybeans).

Subsequently, Act 5 and Act 6 are performed.

Consequently, the customer can surely find a commodity that the customer desires to purchase. Accordingly, the customer can avoid consuming a useless time for searching for commodities in the store. Dissatisfaction and distrust of the customer against the store can be eased.

<Commodity Information Notification Method: Modification 2>

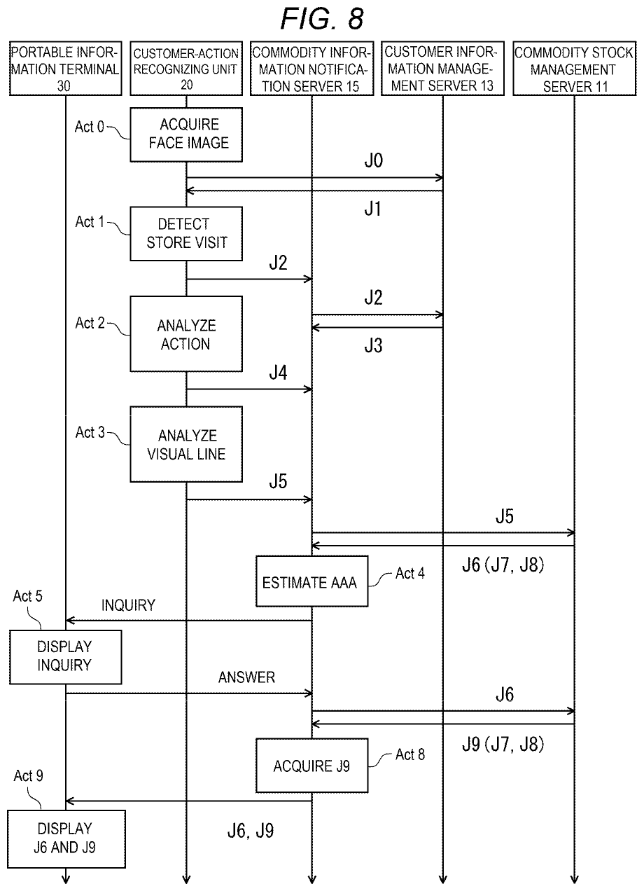

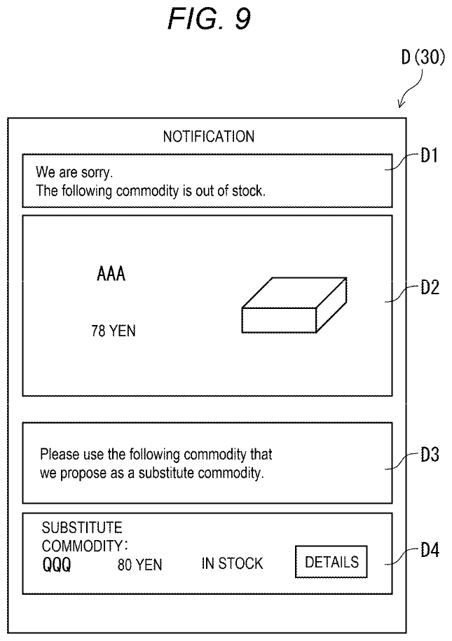

Referring now to FIGS. 8 and 9, if the search target commodity is out of stock, the satisfaction of the customer decreases even if the display position information J8 and the like of the search target commodity is provided.

Accordingly, in Act 6, information concerning a commodity replacing the search target commodity (e.g., commodity information J9 of a substitute) may be provided (e.g., notified) to the customer.

That is, if the stock information J7 is “0” or the like and the customer selects and answers “searching (acquire the display position information J8)” in Act 5, the commodity information notification server 15 transmits the commodity information J6 to the commodity stock management server 11 and instructs the commodity stock management server 11 to search through the commodity stock database 12.

The commodity stock management server 11 specifies a substitute (e.g., a different commodity of the same item or a similar item) based on the commodity information J6.

Similar commodity information is stored in the commodity information J6 as explained below.

For example, if a purchase planned commodity is fermented soybeans (AAA), fermented soybeans (QQQ) and fermented soybeans (RRR) are specified as substitutes (e.g., different commodities of the same item) and are registered as having similar commodity information.

For example, if the purchase planned commodity is cabbage, lettuce and Chinese cabbage are specified as substitutes (e.g., similar items) and registered as the similar commodity information.

The commodity stock management server 11 returns the commodity information J9 of these substitutes to the commodity information notification server 15.

In this way, the commodity information notification server 15 acquires the commodity information J9 (e.g., the display position information J8, the stock information J7, and the like) of the substitutes (Act 8).

The commodity information notification server 15 transmits the commodity information J6 (e.g., the item and the stock information J7) of the search target commodity (AAA) and the commodity information J9 (e.g., the item and the price, the display position information J8, and the stock information J7) of the substitute (QQQ) to the smartphone 30.

As illustrated in FIG. 9, the smartphone 30 displays the information received from the commodity information notification server 15 on the display D (Act 9).

For example, as illustrated in FIG. 5, a message “We are sorry. The following commodity is out of stock” is displayed in the region D1 of the display D.

The commodity information J6 of the search target commodity AAA is displayed in the region D2. Specifically, “AAA, 78 yen” is displayed. The thumbnail image of AAA is also displayed.

An inquiry message “Please use the following commodity that we propose as a substitute commodity” is displayed in the region D3.

The commodity information J9 (the stock information J7 and the like) of the substitute is displayed in the region D4. Specifically, “QQQ, 80 yen, in stock” is displayed. A “details” button is also displayed in the region D4. The display position information J8 and the like of the substitute (QQQ) can also be displayed by touching the “details” button.

Consequently, the customer can learn that the commodity that the customer desires to purchase is out of stock. The customer can also obtain commodity information of the substitute. Accordingly, the customer can avoid wasting time searching for commodities in the store. Dissatisfaction and distrust of the customer against the store can be eased.

If the search target commodity is out of stock, a coupon may be displayed on the smartphone 30.

Arrival schedule information of the search target commodity may be provided. Further, the customer may be able to perform reserved purchase for the search target commodity from the smartphone 30.

With such a method as well, dissatisfaction and distrust of the customer against the store can be eased.

As explained above, with the commodity information notification system and the commodity information notification method in the embodiment, if the customer is searching for a commodity in the store, information concerning the commodity is notified to the smartphone 30 of the customer. Therefore, the customer can surely find a commodity that the customer desires to purchase.

Accordingly, the customer can avoid consuming a useless time for searching for commodities in the store. Dissatisfaction and distrust of the customer against the store can be eased.

If the search target commodity is out of stock, the information concerning the substitute can also be notified. Therefore, dissatisfaction and distrust of the customer against the store can be eased.

Customer store visit detection is not limited to the detection of the customer store visit by the customer-action recognizing unit 20. For example, the customer store visit may be detected using a storefront terminal disposed near the entrance of the store.

Detection of connection of the portable information terminal carried by the customer to the wireless LAN 6 provided in the store may be determined as the customer store visit.

Further, the customer store visit may be detected using position information (e.g., GPS information) of the portable information terminal carried by the customer.

As a method of registering a commodity that the customer plans to purchase, use of a “shopping memo” provided in the Web site is explained above. However, the method is not limited to this. The commodity purchase history information J11 (see FIG. 3D) may be used. That is, the commodity information notification server 15 may select a frequently purchased commodity or a periodically purchased commodity from the customer purchase history information J11 of the customer and automatically register the commodity as the purchase planned commodity.

The portable information terminal carried by the customer is not limited to the smartphone and may be a tablet terminal, a personal computer, or the like.

The commodity stock management server 11, the customer information management server 13, and the commodity information notification server 15 may be respectively individual computers or may be managed by one or two computers.

The embodiment is presented as an example and are not intended to limit the scope of the invention. The new embodiment can be implemented in other various forms. Various omissions, substitutions, and changes can be made without departing from the spirit of the invention. The embodiment and modifications of the embodiments are included in the scope and the gist of the invention and included in the inventions described in claims and the scope of equivalents of the inventions.

What is claimed is:

1. A commodity information notification system comprising:
a commodity stock database configured to store and manage commodity information of commodities in a store;
a customer information database configured to store and manage customer information; and
a server configured to:
detect a store visit of a customer registered in the customer information database,
recognize an action of the customer as a commodity search action using image data from a camera that captures customer actions,
responsive to recognizing the customer action as a commodity search action from the image data, acquire commodity information of a search target commodity from the commodity stock database, and
transmit the commodity information to a portable information terminal carried by the customer.

2. The system according to claim 1, wherein the server is further configured to:
analyze a visual line direction of the customer from the image data, and
estimate the search target commodity based on display position information of commodities stored in the commodity stock database and visual line information of the customer.

3. The system according to claim 2, wherein the display position information comprises at least one of a floor number, an area, a rack number, or a shelf level number.

4. The system according to claim 1, wherein the commodity information includes at least one of a commodity code, an item, a price, a commodity image, display position information, or stock information.

5. The system according to claim 1, wherein the commodity stock database is further configured to store a history of the commodity.

6. The system according to claim 1, wherein the customer information comprises at least one of a customer number, a name, an age, customer terminal information, or face image data of the customer.

7. The system according to claim 1, wherein the server is further configured to estimate the search target commodity based on a commodity purchase history stored in the customer information database and position information of the customer.

8. The system according to claim 7, wherein the server is further configured to estimate the search target commodity based on the purchase planned commodity information registered in the commodity stock database and position information of the customer.

9. The system according to claim 8, wherein the server is configured to transmit the commodity information via an electric communication line.

10. The system according to claim 1, wherein, responsive to determining that the search target commodity is out of stock the server is configured to:
query the commodity stock database using the commodity information; and
determine a substitute commodity to transmit to the portable information terminal.

11. A commodity information notification method comprising:
storing, by a commodity stock database, information of commodities in a store;
storing, by a customer information database, customer information;
detecting, by a server, a store visit of a customer registered in a customer information database;
recognizing, by the server, an action of the customer as a commodity search action using image data from a camera that captures customer actions;
responsive to recognizing the customer action as a commodity search action, acquiring, by the server, commodity information of a search target commodity from a commodity stock database; and
transmitting, by the server, the commodity information to a portable information terminal carried by the customer.

12. The commodity information notification method according to claim 11, further comprising:
analyzing, by the server, a visual line direction of the customer from the image data, and
estimating, by the server, the search target commodity based on display position information of commodities stored in the commodity stock database and visual line information of the customer.

13. The commodity information notification method according to claim 12, wherein the display position information comprises at least one of a floor number, an area, a rack number, or a shelf level number.

14. The commodity information notification method according to claim 11, wherein the commodity information comprises at least one of a commodity code, an item, a price, a commodity image, display position information, or stock information.

15. The commodity information notification method according to claim 11, wherein the commodity stock database is further configured to store a history of the commodity.

16. The commodity information notification method according to claim″, wherein the customer information comprises at least one of a customer number, a name, an age, customer terminal information, or face image data of the customer.

17. The commodity information notification method according to claim 11, further comprising estimating, by the server, the search target commodity based on a commodity purchase history stored in the customer information database and position information of the customer.

18. The commodity information notification method according to claim 17, further comprising estimating, by the server, the search target commodity based on the purchase planned commodity information registered in the commodity stock database and position information of the customer.

19. The commodity information notification method according to claim 18, wherein the server is configured to transmit the commodity information via an electric communication line.

20. The commodity information notification method according to claim 11, wherein, responsive to determining that the search target commodity is out of stock the server is configured to:
query the commodity stock database using the commodity information; and
determine a substitute commodity to transmit to the portable information terminal.
